(19) United States
(12) Patent Application Publication
(10) Pub. No.: US 2011/0195131 A1
(43) Pub. Date: Aug. 11, 2011

(54) DISINFECTANT CLEANER

(75) Inventors: Mario Bouchard, St-Joachim-de-Courval (CA); Jean-Marc Bouchard, Pointe-aux-Trembles (CA)

(73) Assignee: SILLAB DESINFECTION INC., St-Hyacinthe (CA)

(21) Appl. No.: 12/701,365

(22) Filed: Feb. 5, 2010

(51) Int. Cl. A01N 59/16; A01N 59/20; A01P 1/00

(52) U.S. Cl. 424/618; 424/638; 424/649

(57) ABSTRACT

Disclosed is a high efficiency disinfectant cleaner that is stable and shows antibacterial activity. This disinfectant cleaner basically comprises nanoparticles of silver, copper or gold; at least one surfactant which includes a quaternary ammonium surfactant; a solvent; a gelling agent; and water. Thanks to the use of the gelling agent, the disinfection cleaner remains stable and homogenous. The nanoparticles are kept in suspension, since the gelling agent does not allow deposition of them. Since deposition at the bottom of the solution is prevented, agglomeration to ineffective bigger size particles is also inhibited and the disinfectant stability and efficacy are conserved. The improved stability of the composition and the synergic effect of specific ingredients improve the antibacterial efficiency by decreasing tremendously the required killing contact time.

The present invention relates to a disinfectant cleaner that is stable and shows antibacterial activity, and which basically comprises nanoparticles of silver, copper or gold; at least one surfactant which includes a quaternary ammonium surfactant; a solvent; a gelling agent and water.

The invention actually lies in the presence of the gelling agent which permits to obtain a continuous and homogeneous suspension of the nanoparticles and other ingredients and therefore provides a more efficient and stable composition. Such a composition is actually very stable and has a very good antibacterial and/or antimicrobial activity for which contact kill times are decrease tremendously.

### BACKGROUND OF THE INVENTION

Disinfectant cleaners are substances th at are used to destroy or inactivate microorganisms that might carry disease or infection when applied to non-living objects.

Chlorine bleach, such as sodium hypochlorite, is surely the best known disinfectant. It has a broad-spectrum of effectiveness of bleach, and has good germicidal, fungicidal, sproricidal and virucidal activity.

Chlorine bleach owes its efficacy to the nature of the chemical reactivity of the bleach with the microbes. Rather than acting in an inhibitory or specific toxic fashion in the manner of antibiotics, the reaction with the microbial cells, quickly and irreversibly denatures, and often destroys the pathogen.

However, antimicrobial activity does not remain after drying and/or when contact time required for killing pathogenic organism is of a few minutes. It lacks detergency and is therefore a very poor cleaner. In fact, it contains no wetting agents, surfactants or solvents to allow the disinfecting agent to penetrate soils and reach pathogenic microorganisms under it. So, the surfaces to be disinfected must be pre-cleaned before the chlorine bleach will effectively kill germs. Another major disadvantage of chlorine bleach is that it reacts with other chemicals to create toxic products and gases that can be very harmful to humans. Fumes can be irritating and occupants of buildings frequently complain about bleach and bleach-related odours. Another major problem of chlorine bleach is that it discolours fibres and coloured surfaces. It is especially damaging to floor finishes and hard surfaces.

Other well known and used disinfectants are phenols or phenolic disinfectant cleaners. Phenolic disinfectants are effective against bacteria (especially gram positive bacteria) and enveloped viruses. They are not effective against non-enveloped viruses and spores. These disinfectants maintain their activity in the presence of organic material. They are not as corrosive as chlorine bleach but they are still aggressive enough to attack and damage floor finishes and sensitive flooring.

Phenolic disinfectants are generally safe, but prolonged exposure to the skin may cause irritation. They can be toxic to the skin and eyes. Depigmentation can occur with long periods of exposure or use and commonly causes sinus and respiratory tract irritation or problems. The solutions need to be discarded and remixed daily. As per chlorine bleach, this type of disinfectant will discolour fibres and coloured surfaces.

Quaternary ammonium chlorides (also called “Quats”) are usually selected as a main choice by hospitals, medical care facilities and food service. They can be easily combined to other ingredients to form a cleaner. They have detergency power at different degrees depending on their carbon chain length. As the other disinfectants (e.g., phenolics,) they are very effective with gram positive bacteria. However, gram-negative bacteria have been found to survive or grow in these preparations.

Quats provide safe and effective sanitizing and one-step cleaning-disinfecting. Quaternary ammonium chlorides include in particular benzalkonium chloride as active ingredient. The quaternary ammonium chlorides can be formulated with a variety of ingredients to provide a safe and effective neutral pH, disinfectant-cleaner without damaging floor finishes or sensitive floor surfaces. They can be effectively formulated into hospital strength and general disinfectants, disinfectant-cleaners and food contact surface sanitizers. Many public health officials are accepting and recommending “quats” sanitizers as replacements for chlorine bleach sanitizers. In addition, quats are relatively economical and effective odour control agents when used according to label directions.

Quats are actually very effective for destroying a broad spectrum of harmful microorganisms. However, they tend to loose some strength in the presence of organic soils. They also require a very long contact time to achieve a significant kill.

One common problem of all these different types of disinfectant is the long kill time needed to ensure complete and irreversible disinfection. Very often, the kill time is in the range of 10 minutes. This means that the surface to be disinfected must remain wet for at least 10 minutes to be effective. Frequently, this minimum time is not respected. Often misuse occurs because the person performing the disinfection procedure simply misunderstands how the disinfection procedure needs to be performed to achieve the objective of surface disinfection. That is the destruction, mitigation or removal of the pathogens from the surface before they can be transmitted.

Because of this, there has been a growing interest to have a highly efficient broad spectrum antimicrobial cleaner that would have a short kill time. Moreover, there has been a growing interest to have an antimicrobial cleaner that would be very good at cleaning so that disinfection can be performed in a one step process.

Silver has long been known to exhibit a strong toxicity to a wide range of micro-organisms, including gram positive and gram negative bacteria, viruses and fungi. For this reason, silver compounds have been used in the medical field to treat burns and a variety of infections. As a matter of fact, several salts of silver and their derivatives are already employed commercially as antimicrobial agents.

Consequently, and following the increased employment of metals as antibacterial agents, scientists came to study nanoparticles of metallic colloids for their antibacterial property.

Nanotechnology has actually been gaining tremendous impetus in the present century due to its capability of modulating metals into their nanosize, which drastically changes their chemical, physical and optical properties. Silver in particular in the form of silver nanoparticles has made a remarkable comeback as a potential antimicrobial agent in which the nanosize of the particles is intrinsic to the efficiency of the disinfectant. Commendable efforts have thus been made to explore this property which has revealed size dependent interaction of silver and other metallic nanoparticles with bacteria.

Metallic nanoparticles, preferably silver, have thus been extensively studied as a medium for antibacterial effectiveness. However, the bactericidal property of these nanoparticles depends on their stability which gives greater retention time for bacterium-nanoparticle interaction, and therefore efficacy. There lies a strong challenge in preparing metallic nanoparticles that are stable in the presence of the different composites of a good cleaner.

Some cleaners have been developed with this technology.

By way of example, international laid-open application WO/2006/071069 makes reference to a nano-silver detergent and indicates that there is a need for stability when using nanoparticules. This application insists on the use of low concentrations of nanoparticules in order to prevent agglomeration of the latter into bigger size particules followed by precipitation. Of course, if less nanoparticules are used in order to prevent agglomeration and precipitation, less concentrated disinfectant will therefore need a longer kill time in order to be fully antibacterial.

International laid-open patent WO/2006/029213 also discloses the use of a disinfecting agent consisting of silver dihydrogen nitrate which has some stability in solution. It actually discloses compositions in the form of emulsions wherein an emulsifier stabilizes the dispersion. It also discloses that the compositions may in addition include a gelling agent. This again clearly indicates the need for stability in order for a product to retain its antibacterial efficiency.

Of course, the need for stability and nanoparticule concentration in a disinfectant cleaner, does not preclude the need that such a disinfectant clear must respond to the need of the consumers and have a short contact kill time. In all cases, even though the final composition shows antibacterial activity, the provenance of the nanoparticules and how they are formulated with other ingredients, may affect the efficiency of the product and the contact time needed for the antibacterial effect to be complete.

### SUMMARY OF INVENTION

It is therefore the object of the present invention to provide an improved stable disinfectant cleaner which requires very short kill contact time as compared to what is presently being disclosed and known.

More specifically, the present invention is directed to a very high efficiency disinfectant cleaner that is stable and shows antibacterial activity upon contact, said disinfectant cleaner comprising: nanoparticles of silver, copper or gold; at least one surfactant which includes a quaternary ammonium surfactant; a solvent; a gelling agent; and water.

The present invention is based on the discovery that, thanks to the use of a gelling agent which renders the disinfectant cleaner stable and homogeneous, and thanks to an accumulative antibacterial effect from both the type of the nanoparticule used and the quaternary ammonium surfactant, the product is ultra efficient and antibacterial at very short kill contact time.

### DETAILED DESCRIPTION OF THE INVENTION

As aforesaid, the antibacterial disinfectant cleaner according to the invention comprises nanoparticles of silver, gold or copper. Preferably, such nanoparticles are made of silver. The concentration of the nanoparticles within the composition of the disinfectant cleaner may range from 0.5% w/w for a ready to use antibacterial cleaner up to 99.3% w/w for a concentrated version of the disinfecting cleaner with a preference for a concentration of approximately 5%.

As source of said nanoparticles, use can be made of the antibacterial solutions disclosed in international laid-open patent application No. WO2006/105669A1 in the name of CTT Group Inc.

The disinfectant cleaner according to the invention also comprises at least one and preferably two surfactants. The first surfactant which must be present, is a quaternary ammonium surfactant selected from the group consisting of cetyl trimethyl ammonium chloride, dialkyl dimethyl ammonium chloride, alkyl trimethyl ammonium chloride, alkyl dimethylbenzyl ammonium chloride and alkyl ethylbenzyl ammonium chloride. This surfactant even though not recognized as a direct disinfecting agent, helps in the cleaning efficiency of the disinfectant cleaner, and, more importantly, acts as a boosting disinfecting agent to the silver nanoparticles. The second surfactant that can be used is preferably a non-ionic alkyl glycoside with a carbon chain length ranging from C8 to C16, which offers stability, high biodegradation and helps the cleaning efficiency. More preferably, said non-ionic alkyl glycoside is a lauryl glucoside, coco glucoside, decyl glucoside or caprylyl/capryl glucoside.

The quaternary amine surfactant can be present in a concentration ranging from 0.1 to 20%, preferably in between 1 to 3% w/w of active surfactant. The non-ionic alkyl derived glycoside surfactant can be present in a concentration ranging between 0.1% to 5% w/w of the active surfactant.

The disinfectant cleaner according to the invention further comprises a solvent. The concentration of solvent may range between 0.5% and 10% w/w, preferably between 2 and 3% w/w. Non-restrictive examples of solvent that can be used are propylene glycol methyl ether, dipropylene glycol methyl ether, propylene glycol monobutyl ether, ethylene glycol monobutyl ether and diethylene glycol monobutyl ether.

Last of all, the disinfectant cleaner according to the invention comprises a gelling agent. Such a gelling agent permits stabilization of the disinfectant cleaner by keeping the silver nanoparticles in suspension. The concentration of gelling agent may range between 0.1% and 5% w/w depending on the kind of gelling agent that is used, preferably between 0.4% and 0.8%. Non-restrictive examples of gelling agents include hydroxylpropyl methyl cellulose, hydroxyethyl cellulose or cetyl hydroxyethyl cellulose or guar hydroxypropyltrimethyl ammonium chloride, or guar gum, or guar 2-hydroxypropyl ether, or hectorite, or Polyquaternium-37 or methyl cellulose.

The disinfectant cleaner according to the invention finally comprises water. From a practical standpoint, deionized water is usually present in the source of nanoparticles used in the composition, like the one sold by CTT Group Inc.

Of course, if needs be, deionized water can added to the final composition of the disinfection cleaner to complete it.

So, the disinfectant cleaner according to the invention preferably comprises:
from 0.5% to 99.3% by weight of nanoparticles of silver, copper or gold;
from 0.1 to 20% by weight of at least one surfactant;
from 0.5 to 10% by weight of solvent; and
from 0.1 to 5% by weight of gelling agent;
the balance consisting of water.

As aforesaid, the invention is based on the discovery that such a composition provides high stability, high cleaning efficiency and antibacterial activity. Moreover, the contact times normally required to kill the pathogens are shortened tremendously.

### Example

In the following example, the percentages are expressed in weight if not otherwise specified.

In a vessel, 843.7 g of deionized water was poured and agitation was started. 5.5 g of hydroxyethylcellulose acting as a gelling agent was scattered on top of the water. The solution was then heated up to 50° C., kept at that temperature and mixed for one hour. After decrease of the temperature to 35° C., 10 g of a 50-60% coco glucoside solution and 70 g of a 25% cetyl trimethyl ammonium chloride solution were added as surfactants. After mixing, sulphuric acid contained in a 25% water solution was added to adjust the pH to approximately 3.6. Finally, 20 g of propylene glycol n-butyl ether used as a solvent, was added together with 50 g of a silver nanoparticle solution sold by the CTT Group Inc. under the designation of G300. Such a solution basical comprises a silver salt, water, and at least one surfactant.

So, the above composition was basically containing, expressed in weight percentages:
5.00% of the nanoparticle solution;
1.00% of the first surfactant;
7.00% of the second surfactant;
0.08% of an acid solution;
2.00% of a solvent;
0.55% of the gelling agent; and
84.37% of demineralised water.

A sample of this disinfectant cleaner was tested for antibacterial activity on E. Coli. This disinfectant cleaner showed an efficacy of 99.999% upon contact (see Test 1).

The same sample was tested for antibacterial activity eight weeks later once again on the E. Coli. Again, the disinfectant cleaner has showed efficacy of 99.999% upon contact (see Test 2). Therefore, even after eight weeks, the composition was still showing an excellent antimicrobial efficacy due to the stability of the nanoparticles suspension contained therein.

TEST 1

| | BACTERIA | BACTERIA | | |
|---|---|---|---|---|
| CONTACT | COUNT | COUNT | EFFICACY | EFFICACY |
| TIME | UFC/ML | UFC/ML | (%) | (%) |
| (SECOND) | TEST 1 | TEST 2 | TEST 1 | TEST 2 |
| 0 | <10 | <10 | >99.999 | >99.999 |
| 10 | <10 | <10 | >99.999 | >99.999 |
| 30 | <10 | <10 | >99.999 | >99.999 |

TEST 2

| | BACTERIA | BACTERIA | | |
|---|---|---|---|---|
| CONTACT | COUNT | COUNT | EFFICACY | EFFICACY |
| TIME | UFC/ML | UFC/ML | (%) | (%) |
| (SECOND) | TEST 1 | TEST 2 | TEST 1 | TEST 2 |
| 0 | <10 | <10 | >99.999 | >99.999 |
| 10 | <10 | <10 | >99.999 | >99.999 |
| 30 | <10 | <10 | >99.999 | >99.999 |

What is claimed is:

1. A disinfectant cleaner that is stable and shows antibacterial activity, said disinfectant cleaner comprising:
nanoparticles of silver, copper or gold;
at least one surfactant, including a quaternary ammonium surfactant;
at least one solvent;
a gelling agent; and
demineralised water

2. The disinfectant cleaner of claim 1, wherein said quaternary ammonium surfactant is selected from the group consisting of dialkyl dimethyl ammonium chloride, alkyl trimethyl ammonium chloride, alkyl dimethylbenzyl ammonium chloride and alkyl dimethylethylbenzyl ammonium chloride.

3. The disinfectant cleaner of claim 2, wherein said quaternary ammonium surfactant is cetyl trimethyl ammonium chloride.

4. The disinfectant cleaner of claim 2, wherein said at least one surfactant also includes a surfactant that is a non-ionic alkyl glycoside with a carbon chain length ranging from C8 to C16.

5. The disinfectant cleaner of claim 4, wherein said non-ionic alkyl glycoside is a lauryl glucoside, coca glucoside, decyl glucoside or caprylyl/capryl glucoside.

6. The disinfectant cleaner of claim 5, wherein said non-ionic alkyl glycoside is a coca glucoside.

7. The disinfectant cleaner of claim 2, wherein said solvent is selected from the group consisting alkylene glycol monoalkyl ether solvents, alkylene glycol dialkyl ether solvents, dialkylene glycol alkyl ether solvents and trialkylene glycol alkyl ether solvents.

8. The disinfectant cleaner of claim 7, wherein said solvent is selected from the group consisting of propylene glycol monomethyl ether, propylene glycol dimethyl ether, propylene glycol n-butyl ether, dipropylene glycol monomethyl ether, dipropylene glycol dimethyl ether, dipropylene glycol monobutyl ether, dipropylene glycol n-butyl ether, ethylene glycol monomethyl ether, ethylene glycol dimethyl ether, ethylene glycol monoethyl ether, ethylene glycol diethyl ether, ethylene glycol monopropyl ether, ethylene glycol dipropyl ether, ethylene glycol monophenyl ether, ethylene glycol monobenzyl ether, ethylene glycol monobutyl ether, ethylene glycol dibutyl ether, diethylene glycol monomethyl ether, diethylene glycol dimethyl ether, diethylene glycol monoethyl ether, diethylene glycol diethyl ether, diethylene glycol dipropyl ether, diethylene glycol monophenyl ether, diethylene glycol monobenzyl ether, diethylene glycol monobutyl ether and diethylene glycol dibutyl ether, propylene glycol n-propyl ether.

9. The disinfectant cleaner of claim 2, wherein said gelling agent is a cellulose derivative or a galactomannan derivative selected from the group consisting of hydroxylpropyl methyl cellulose, hydroxyethyl cellulose, cetyl hydroxyethyl cellulose and 2-hydroxypropyltrimethyl ammonium chloride.

10. The disinfectant cleaner of claim 9, wherein said gelling agent is hydroxyethyl cellulose.

11. The disinfectant cleaner of claim 2, wherein said nanoparticles are nanoparticles of silver.

12. The disinfectant cleaner of claim 2, which comprises:
from 0.5% to 99.3% by weight of said nanoparticles of silver, copper or gold;
from 0.1 to 20% by weight of said at least one surfactant;
from 0.5 to 10% by weight of said solvent; and
from 0.1 to 5% by weight of said gelling agent;
the balance consisting of demineralised water.

13. The disinfectant cleaner of claim 12, wherein:
said at least one surfactant also includes a surfactant that is a non-ionic alkyl glycoside with a carbon chain length ranging from C8 to C16;
said solvent is selected from the group consisting alkylene glycol monoalkyl ether solvents, alkylene glycol dialkyl ether solvents, dialkylene glycol alkyl ether solvents and trialkylene glycol alkyl ether solvents; and
said gelling agent is a cellulose derivative or a galactomannan derivative selected from the group consisting of hydroxylpropyl methyl cellulose, hydroxyethyl cellulose, cetyl hydroxyethyl cellulose and 2-hydroxypropyltrimethyl ammonium chloride.

14. The disinfectant cleaner of claim 13, wherein:
said non-ionic alkyl glycoside is a lauryl glucoside, coco glucoside, decyl glucoside or caprylyl/capryl glucoside;
said solvent is selected from the group consisting of propylene glycol monomethyl ether, propylene glycol dimethyl ether, propylene glycol n-butyl ether, dipropylene glycol monomethyl ether, dipropylene glycol dimethyl ether, dipropylene glycol monobutyl ether, dipropylene glycol n-butyl ether, ethylene glycol monomethyl ether, ethylene glycol dimethyl ether, ethylene glycol monoethyl ether, ethylene glycol diethyl ether, ethylene glycol monopropyl ether, ethylene glycol dipropyl ether, ethylene glycol monophenyl ether, ethylene glycol monobenzyl ether, ethylene glycol monobutyl ether, ethylene glycol dibutyl ether, diethylene glycol monomethyl ether, diethylene glycol dimethyl ether, diethylene glycol monoethyl ether, diethylene glycol diethyl ether, diethylene glycol dipropyl ether, diethylene glycol monophenyl ether, diethylene glycol monobenzyl ether, diethylene glycol monobutyl ether and diethylene glycol dibutyl ether, propylene glycol n-propyl ether; and
said gelling agent is hydroxyethyl cellulose.

15. The disinfectant cleaner of claim 14, wherein said nanoparticles are nanoparticles of silver.
